(19) United States
(12) Patent Application Publication
(10) Pub. No.: US 2018/0112818 A1
(43) Pub. Date: Apr. 26, 2018

(54) Mounting Assembly

(71) Applicant: Globe Union Industrial Corp., Taichung City 42760 (TW)

(72) Inventor: Dulun Chang, Shen Zen (CN)

(21) Appl. No.: 15/299,529

(22) Filed: Oct. 21, 2016

(51) Int. Cl. F16M 13/02; A47K 10/10; A47K 17/02

(52) U.S. Cl. CPC F16M 13/02; A47K 2201/02; A47K 17/022; A47K 10/10

(57) ABSTRACT

A mounting assembly contains: a body, an engagement strap, and a retaining loop. The body includes an abutting plane, an opposite face, a threaded orifice, a top edge, and a bottom edge, wherein the abutting plane has a connection seat adjacent to the threaded orifice. The engagement strap includes a coupling portion, a pull ring, a toothed section, and a fitting section. The engagement strap is limited on an insertion position and is rotated on an installation position perpendicular to the body. The retaining loop includes an opening and a locking slot, wherein the locking slot accommodates the fitting section, and as the retaining loop moves to the toothed section of the engagement strap, the locking slot movably engages with the toothed section until the retaining loop contacts with a wall, and wherein a part of the engagement strap outside the retaining loop is cut or is snapped off.

### FIELD OF THE INVENTION

The present invention relates to a mounting assembly, and more particularly to the mounting assembly being applied to fix a bathroom accessory.

### BACKGROUND OF THE INVENTION

A conventional mounting assembly is employed to fix bathroom accessory (such as armrest or towel rack) on a wall by way of wall anchors and screw bolts. However, when the wall is hollow and thin, the wall anchors or the screw bolts cannot lock the bathroom accessory on the wall securely.

A mounting mechanism for securing an article to a wall is disclosed in U.S. Pat. No. 7,828,501B2. The mounting mechanism includes an insertion member, a base member, and a tab member. The insertion member has at least one hub formed thereon. The base member has a flange and at least one arm depending from the flange. The flange defines an insertion hole, and the at least one arm includes a guide. When the insertion member is provided in the insertion hole, the guide receives the at least one hub. The guide directs movement of the insertion member relative to the base member. The insertion member and the base member include a ratchet mechanism for maintaining the position of the insertion member relative to the base member. The ratchet mechanism can include a pawl formed on the at least one hub and at least one indentation provided on the guide. The pawl can interact with the at least one indentation. The tab member can be removably coupled to the insertion member. The tab member can be used to articulate the insertion member from an insertion orientation to an installed orientation.

Nevertheless, the mounting mechanism is complicated and is produced at high fabrication cost. In addition, the mounting mechanism is operated troublesomely.

Another mounting mechanism is disclosed in CN 1183333C and contains a metal fixer and a holding assembly. The holding assembly includes two positioning racks capable of being manually snapped off and includes a fitting loop retained on the two positioning racks. A first end of each of the two positioning racks is rotatably connected on the metal fixer. Said each positioning rack is rotated to form a straight line with the metal fixer so that the metal fixer inserts through a through orifice of a substrate and is rotated to be perpendicular to said each positioning rack and to abut against a first side surface of the substrate, and the fitting loop is moved to contact with a second side surface of the substrate along said each positioning rack. Thereafter, a part of said each positioning rack outside the fitting loop is snapped off. Preferably, a threaded nut on the metal fixer is used to fix the bathroom accessory, and the substrate is a thin wall or a hollow wall.

The metal fixer is too thin to support a heavy object, and the two positioning racks are operated inconveniently and interfere with each other.

The present invention has arisen to mitigate and/or obviate the afore-described disadvantages.

### SUMMARY OF THE INVENTION

The primary objective of the present invention is to provide a mounting assembly which is simplified and is produced at low fabrication cost.

To obtain the above objective, a mounting assembly provided by the present invention contains: a body, an engagement strap, and a retaining loop.

The body is an elongated plate and includes an abutting plane, an opposite face opposite to the abutting plane, a threaded orifice passing through the abutting plane and the opposite face, a top edge, and a bottom edge. A distance between the threaded orifice and the top edge is longer than a distance between the threaded orifice and the bottom edge, and the abutting plane has a connection seat arranged on a lower end thereof adjacent to the threaded orifice.

The engagement strap includes a coupling portion formed on a first end thereof, a pull ring mounted on a second end thereof, a toothed section arranged between the coupling portion and the pull ring, and a fitting section defined between the toothed section and the pull ring. The coupling portion of the engagement strap is parallelly in connection with the connection seat of the body so that the engagement strap is limited on an insertion position, and the engagement strap being rotated on an installation position perpendicular to the body. The body and a part of the engagement strap are inserted through an affix hole of a wall on the insertion position.

The retaining loop includes an opening defined on a peripheral side thereof, and the retaining loop includes a locking slot communicating with the opening, wherein the locking slot accommodates the fitting section of the engagement strap, and as the retaining loop moves to the toothed section of the engagement strap, the locking slot movably engages with the toothed section until the retaining loop contacts with the wall; and wherein another part of the engagement strap outside the retaining loop is cut or is snapped off.

Preferably, the abutting plane of the body has a recess formed on a bottom thereof and extending toward the connection seat, and the abutting plane has a first stop fringe arranged on a bottom of the recess so as to stop the engagement strap, hence the engagement strap is limited on the insertion position. The connection seat has a notch communicating with the recess and has a second stop fringe defined thereon so as to stop the engagement strap, hence the engagement strap is limited and rotated on the installation position.

Preferably, the connection seat further has two apertures defined on two sides of the notch, respectively; the coupling portion of the engagement strap has two flexible posts extending outwardly from two sides thereof respectively, and each of the two flexible posts is rotatably connected with each of the two apertures of the connection seat.

Preferably, the abutting plane of the body has a protrusion surrounding the threaded orifice and configured to retain in the affix hole of the wall.

Preferably, the body further includes a holder and a screw nut fixed in the holder; the screw nut has the threaded orifice defined therein; and the holder has two through orifices arranged on two ends of the screw nut, individually.

Preferably, the holder is injection molded from plastic material and covers the screw nut.

Preferably, the opposite face of the body obliquely extends to the top edge and the bottom edge from the threaded orifice so that a thickness of the body on the threaded orifice is more than those of the top edge and the bottom edge.

Preferably, the toothed section of the engagement strap has multiple first teeth; and the locking slot of the retaining loop has at least one second tooth, such that at least one of the multiple first teeth of the engagement strap retains with the at least one second tooth of the locking slot of the retaining loop.

Preferably, a width of the fitting section of the engagement strap is less than the toothed section, hence when the fitting section moves into the locking slot via the opening, the toothed section is not removed from the locking slot backward.

Preferably, the retaining loop further includes a limiting rib arranged on the peripheral side thereof so as to engage with the affix hole of the wall.

### BRIEF DESCRIPTION OF THE DRAWINGS

FIG. 1 is a perspective view showing the assembly of a mounting assembly according to a preferred embodiment of the present invention.

FIG. 2 is a perspective view showing the exploded components of the mounting assembly according to the preferred embodiment of the present invention.

FIG. 3 is another perspective view showing the exploded components of the mounting assembly according to the preferred embodiment of the present invention.

FIG. 4 is a cross-sectional perspective view showing the assembly of a part of the mounting assembly according to the preferred embodiment of the present invention.

FIG. 5 is another cross-sectional perspective view showing the assembly of a part of the mounting assembly according to the preferred embodiment of the present invention.

FIG. 6 is also another cross-sectional perspective view showing the assembly of a part of the mounting assembly according to the preferred embodiment of the present invention.

FIG. 7 is also another perspective view showing the assembly of a part of the mounting assembly according to the preferred embodiment of the present invention.

FIG. 8 is also still cross-sectional perspective view showing the assembly of a part of the mounting assembly according to the preferred embodiment of the present invention.

FIGS. 9-14 are a cross-sectional perspective view showing the operation of the mounting assembly according to the preferred embodiment of the present invention.

FIG. 15 is a cross sectional view showing the operation of the mounting assembly according to the preferred embodiment of the present invention.

### DETAILED DESCRIPTION OF THE PREFERRED EMBODIMENTS

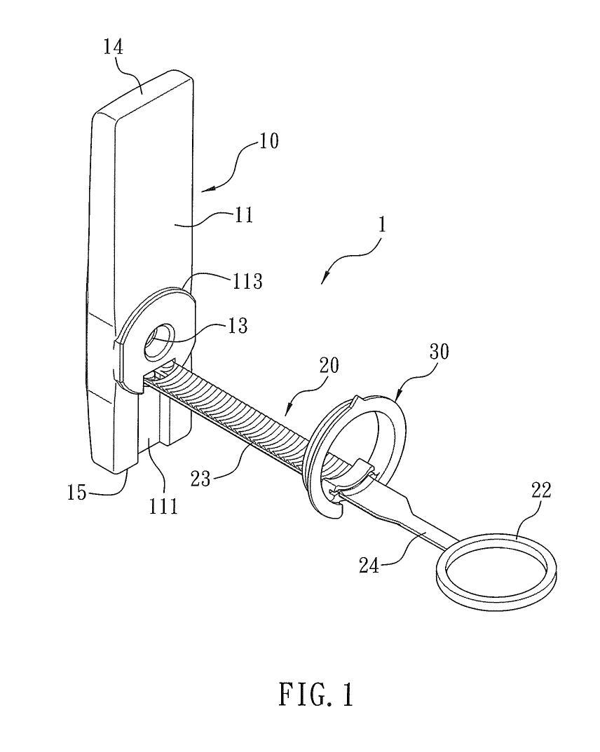

With reference to FIGS. 1-3, a mounting assembly 1 according to a preferred embodiment of the present invention is applied to fix a bathroom accessory and comprises: a body 10, an engagement strap 20, and a retaining loop 30.

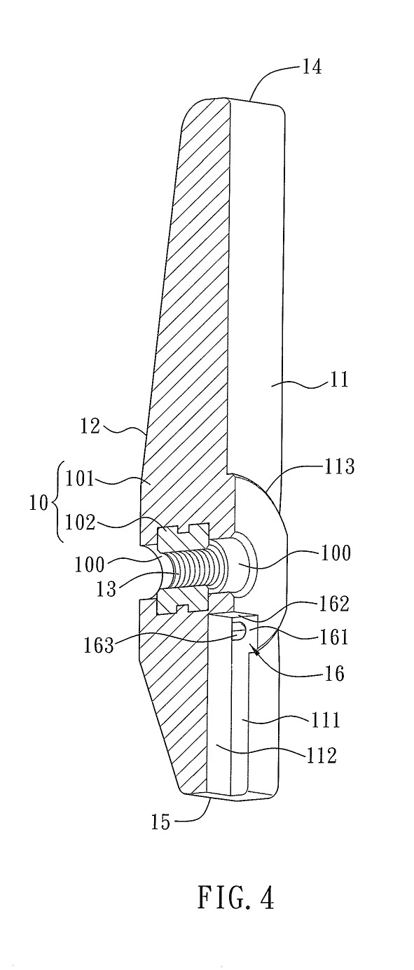

The body 10, as shown in FIG. 4, is an elongated plate, and the body 10 includes an abutting plane 11, an opposite face 12 opposite to the abutting plane 11, a threaded orifice 13 passing through the abutting plane 11 and the opposite face 12, a top edge 14, and a bottom edge 15, wherein a distance between the threaded orifice 13 and the top edge 14 is longer than a distance between the threaded orifice 13 and the bottom edge 15; and the abutting plane 11 has a connection seat 16 arranged on a lower end thereof adjacent to the threaded orifice 13.

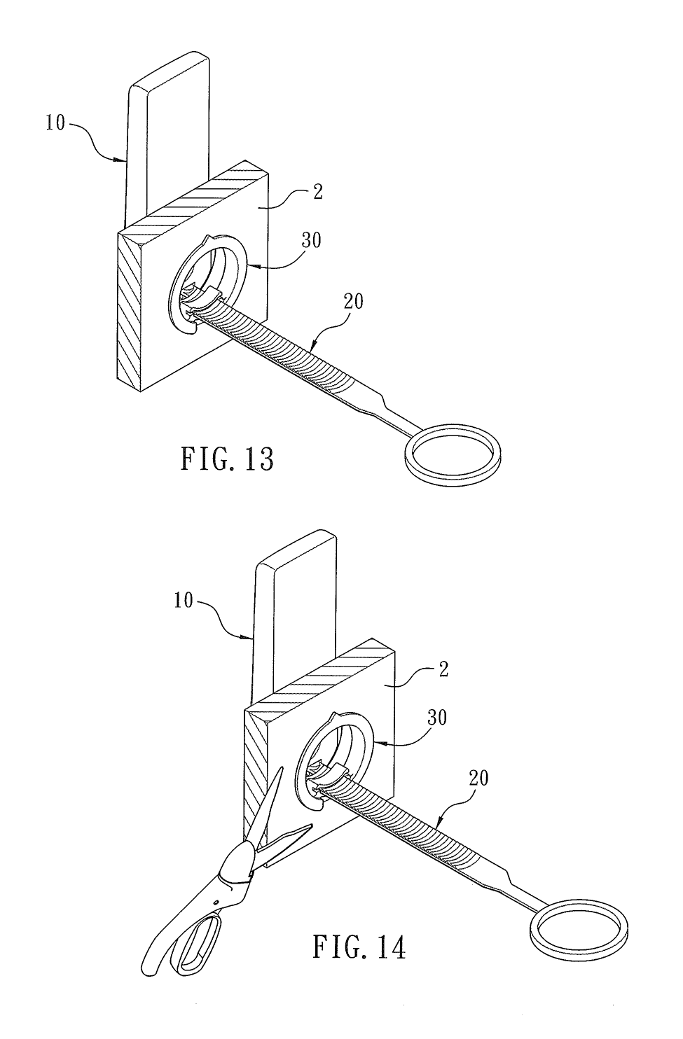

The engagement strap 20 includes a coupling portion 21 formed on a first end thereof, a pull ring 22 mounted on a second end thereof, a toothed section 23 arranged between the coupling portion 21 and the pull ring 22, and a fitting section 24 defined between the toothed section 23 and the pull ring 22. The coupling portion 21 of the engagement strap 20 is parallelly in connection with the connection seat 16 of the body 10, and the engagement strap 20 is limited on an insertion position after being inserted into an affix hole 2a of a wall 2 with the body 10, as illustrated in FIG. 9, and the engagement strap 20 is rotated on an installation position perpendicular to the body 10, as shown in FIG. 11. The body 10 and a part of the engagement strap 20 are inserted through the affix hole 2a of the wall 2 on the insertion position.

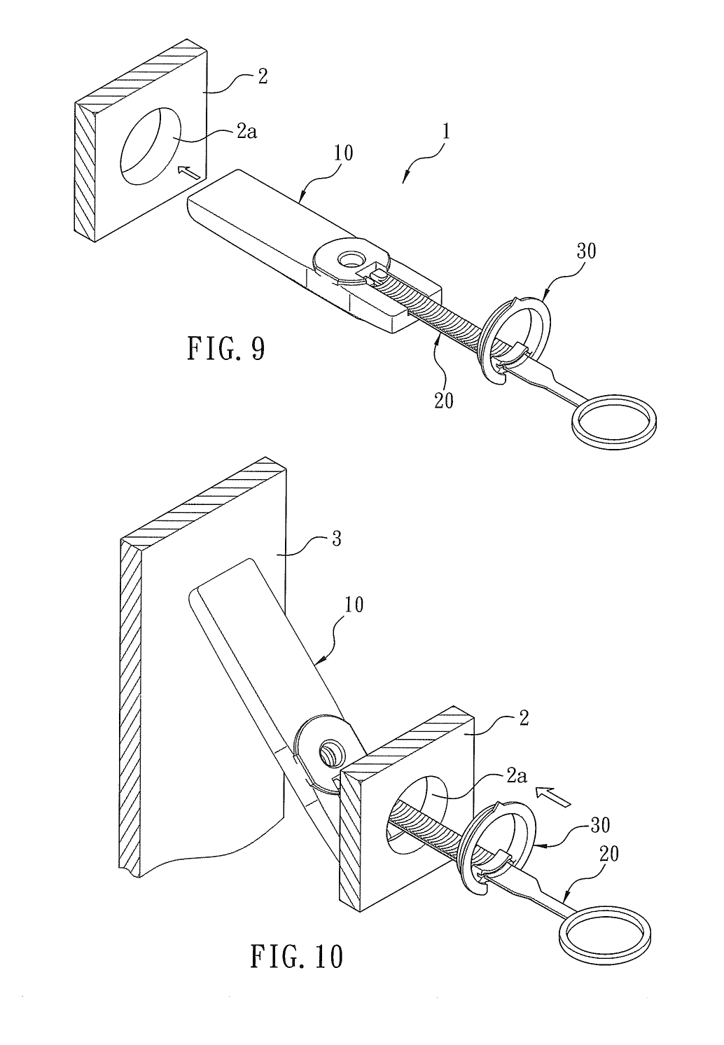

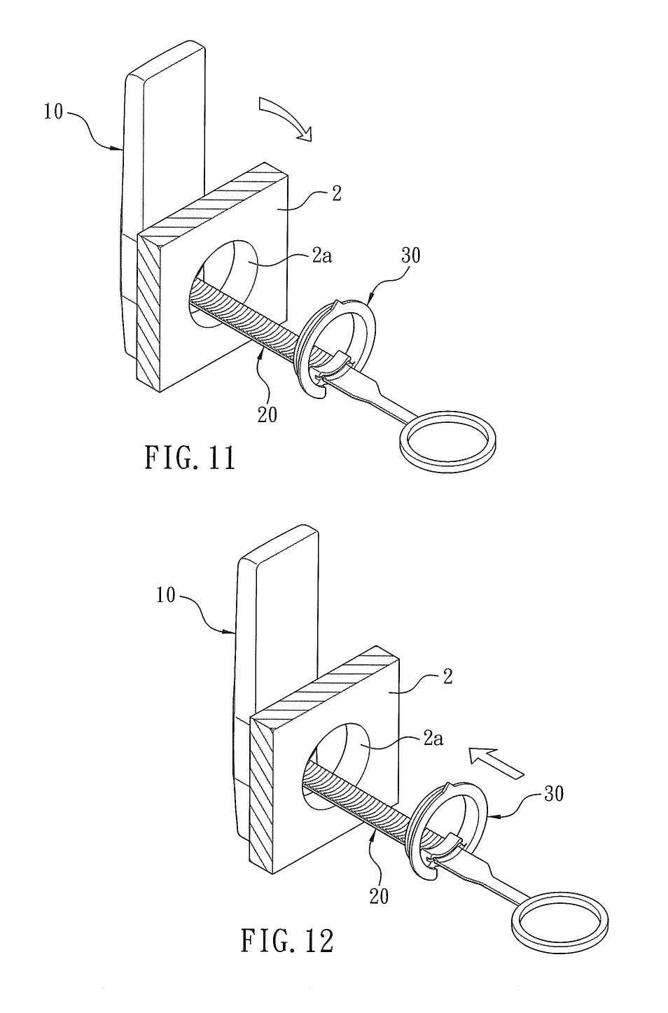

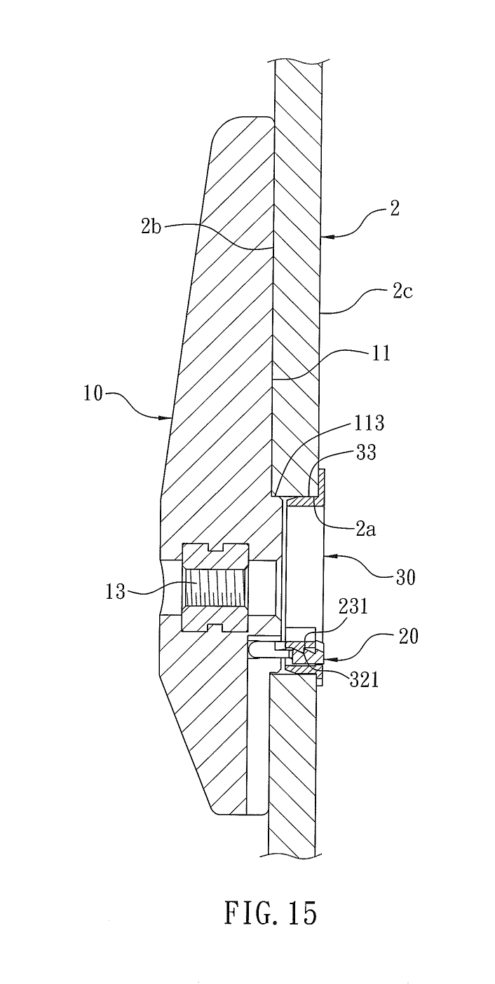

Referring to FIGS. 7 and 8, the retaining loop 30 includes an opening 31 defined on a peripheral side thereof, and the retaining loop 30 includes a locking slot 32 communicating with the opening 31, wherein the locking slot 32 accommodates the fitting section 24 of the engagement strap 20, and as the retaining loop 30 moves to the toothed section 23 of the engagement strap 20, the locking slot 32 movably engages with the toothed section 23 until the retaining loop 30 contacts with the wall 2, as shown in FIG. 13. Another part of the engagement strap 20 outside the retaining loop 30 is cut or is snapped off, as shown in FIGS. 14 and 15.

Referring to FIG. 4, the abutting plane 11 of the body 10 has a recess 111 formed on a bottom thereof and extending toward the connection seat 16, and the abutting plane 11 has a first stop fringe 112 arranged on a bottom of the recess 111 so as to stop the engagement strap 20, hence the engagement strap 20 is limited on the insertion position. The connection seat 16 has a notch 161 communicating with the recess 111 and has a second stop fringe 162 defined thereon so as to stop the engagement strap 20, hence the engagement strap 20 is limited and rotated on the installation position.

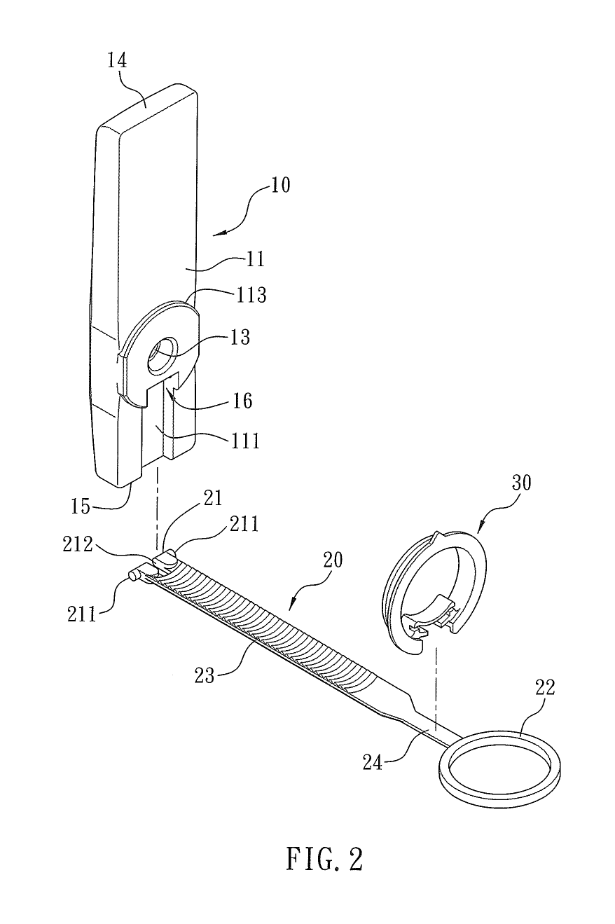

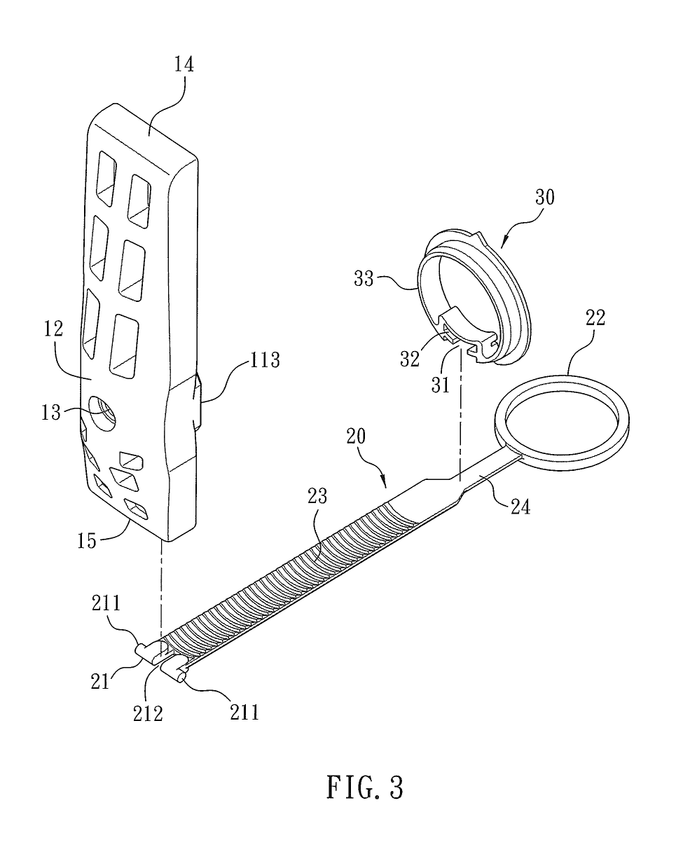

With reference to FIGS. 2 and 3, the connection seat 16 further has two apertures 163 defined on two sides of the notch 161, respectively. The coupling portion 21 of the engagement strap 20 has two flexible posts 211 extending outwardly from two sides thereof respectively, and each of the two flexible posts 211 is rotatably connected with each of the two apertures 163 of the connection seat 16, wherein between the two flexible posts 211 is defined a cutout 212 so that the two flexible posts 211 flexibly expend outwardly or retract inwardly by using the cutout 212.

Referring to FIGS. 1 to 3, the abutting plane 11 of the body 10 has a protrusion 113 surrounding the threaded orifice 13 and configured to retain in the affix hole 2a of the wall 2, thus fixing the mounting assembly 1 on the wall 2 quickly. Preferably, an object hung on the bathroom accessory or an action force exerted by user spreads to the wall 2 via the affix hole 2a so as to enhance a support capacity of the mounting assembly 1.

Referring to FIGS. 4 to 6, the body 10 further includes a holder 101 and a screw nut 102 fixed in the holder 101, and the screw nut 102 has the threaded orifice 13 defined therein. The holder 101 has two through orifices 100 arranged on two ends of the screw nut 102, individually. The holder 101 is injection molded from plastic material and covers the screw nut 102.

The opposite face 12 of the body 10 obliquely extends to the top edge 14 and the bottom edge 15 from the threaded orifice 13 so that a thickness of the body 10 on the threaded orifice 13 is more than those of the top edge 14 and the bottom edge 15, hence when the body 10 is inserted into a fixing space behind the wall 2 via the affix hole 2a, it is adjustably moved and is positioned easily, for example, the body 10 is moved to a vertical state and abuts against an internal face 2b of the wall 2, as shown in FIGS. 10 and 11.

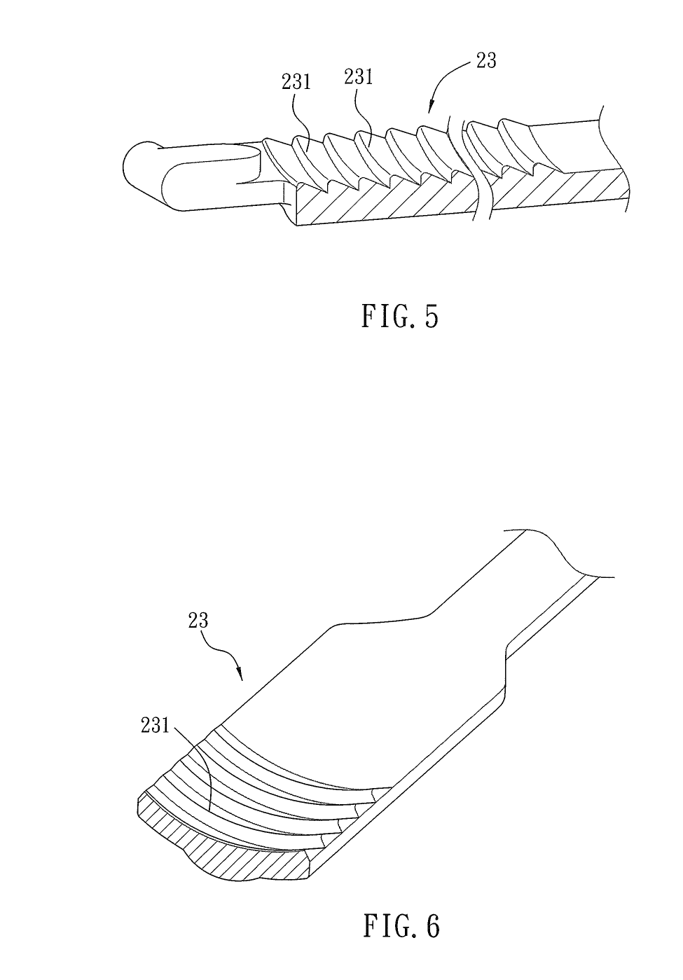

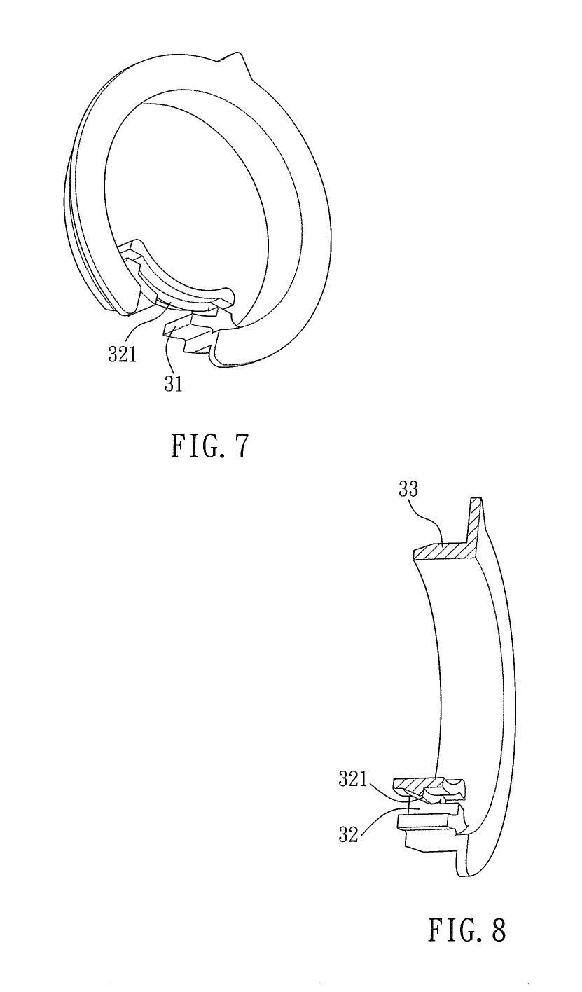

As illustrated in FIGS. 5 and 6, the toothed section 23 of the engagement strap 20 has multiple first teeth 231, and the locking slot 32 of the retaining loop 30 has at least one second tooth 321, as shown in FIGS. 7 and 8, such that at least one of the multiple first teeth 231 of the engagement strap 20 retains with the at least one second tooth 321 of the locking slot 32 of the retaining loop 30. In this embodiment, the locking slot 32 has a second tooth 321.

A width of the fitting section 24 of the engagement strap 20 is less than the toothed section 23, hence when the fitting section 24 moves into the locking slot 32 via the opening 31, the toothed section 23 is not removed from the locking slot 32 backward, and the engagement strap 20 is pushed forward the internal face 2b of the wall 2 until the retaining loop 30 abuts against an external face 2c of the wall 2.

With reference to FIGS. 8 and 15, the retaining loop 30 further includes a limiting rib 33 arranged on the peripheral side thereof so as to engage with the affix hole 2a of the wall 2, hence the object hung on the bathroom accessory or the action force exerted by the user spreads to the wall 2 via the affix hole 2a so as to enhance the support capacity of the mounting assembly 1.

In a test, when the bathroom accessory is an armrest, the mounting assembly 1 of the present invention is capable of supporting the action force of 300 lb.

The affix hole 2a is drilled on the wall 2 and its diameter is 24.5 mm.

As the engagement strap 20 is limited on the insertion position after being inserted into the affix hole 2a of the wall 2 with the body 10, the body 10 is parallel to the engagement strap 20 so as to be inserted into the wall 2 via the affix hole 2a, as shown in FIG. 9.

As the wall 2 is hollow, a reinforcement fence 3 is arranged behind the wall 2 so that when the top edge 14 of the body 10 contacts with the reinforcement fence 3, the body 10 is moved to the vertical state by using the threaded orifice 13 as illustrated in FIG. 10, and the pull ring 22 is pulled backward so that the abutting plane 11 of the body 10 abuts against the internal face 2b of the wall 2, as shown in FIG. 11.

Referring to FIG. 12, the retaining loop 30, retaining with the toothed section 23, is moved to the coupling portion 21 until contacting the external face 2c of the wall 2 (as illustrated in FIG. 13). Thereafter, said another part of the engagement strap 20 outside the retaining loop 30 is cut or snapped off, as shown in FIG. 14.

As the wall 2 is solid, the body 10 is adjustably moved and positioned after inserting through the affix hole 2a, and the engagement strap 20 is pulled backward, thus abutting the mounting assembly 1 against the wall 2.

Accordingly, the mounting assembly 1 is fixed and abuts against the wall 2 easily and has strong support capacity. Preferably, the mounting assembly 1 is simplified and is produced at low fabrication cost.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A mounting assembly comprising:
a body being an elongated plate, and the body including an abutting plane, an opposite face opposite to the abutting plane, a threaded orifice passing through the abutting plane and the opposite face, a top edge, and a bottom edge; a distance between the threaded orifice and the top edge being longer than a distance between the threaded orifice and the bottom edge; and the abutting plane having a connection seat arranged on a lower end thereof adjacent to the threaded orifice;
an engagement strap including a coupling portion formed on a first end thereof, a pull ring mounted on a second end thereof, a toothed section arranged between the coupling portion and the pull ring, and a fitting section defined between the toothed section and the pull ring; the coupling portion of the engagement strap being parallelly in connection with the connection seat of the body so that the engagement strap is limited on an insertion position, and the engagement strap being rotated on an installation position perpendicular to the body; the body and a part of the engagement strap being inserted through a wall having an affix hole on the insertion position;
a retaining loop including an opening defined on a peripheral side thereof, and the retaining loop including a locking slot communicating with the opening; wherein the locking slot accommodates the fitting section of the engagement strap, and as the retaining loop moves to the toothed section of the engagement strap, the locking slot movably engages with the toothed section until the retaining loop contacts with the wall; and wherein another part of the engagement strap outside the retaining loop is cut or is snapped off;
wherein the abutting plane of the body has a recess formed on a bottom thereof and extending toward the connection seat, and the abutting plane has a first stop fringe arranged on a bottom of the recess so as to stop the engagement strap, hence the engagement strap is limited on the insertion position; the connection seat has a notch communicating with the recess and has a second stop fringe defined thereon so as to stop the engagement strap, hence the engagement strap is limited and rotated on the installation position.

2. (canceled)

3. The mounting assembly as claimed in claim 1, wherein the connection seat further has two apertures defined on two sides of the notch, respectively; the coupling portion of the engagement strap has two flexible posts extending outwardly from two sides thereof respectively, and each of the two flexible posts is rotatably connected with each of the two apertures of the connection seat.

4. The mounting assembly as claimed in claim 1, wherein the abutting plane of the body has a protrusion surrounding the threaded orifice and configured to retain in the affix hole.

5. The mounting assembly as claimed in claim 1, wherein the body further includes a holder and a screw nut fixed in the holder; the screw nut has the threaded orifice defined therein; and the holder has two through orifices arranged on two ends of the screw nut, individually.

6. The mounting assembly as claimed in claim 5, wherein the holder is injection molded from plastic material and covers the screw nut.

7. The mounting assembly as claimed in claim 1, wherein the opposite face of the body obliquely extends to the top edge and the bottom edge from the threaded orifice so that a thickness of the body on the threaded orifice is more than those of the top edge and the bottom edge.

8. The mounting assembly as claimed in claim 1, wherein the toothed section of the engagement strap has multiple first teeth; and the locking slot of the retaining loop has at least one second tooth, such that at least one of the multiple first teeth of the engagement strap retains with the at least one second tooth of the locking slot of the retaining loop.

9. The mounting assembly as claimed in claim 1, wherein a width of the fitting section of the engagement strap is less than the toothed section, hence when the fitting section moves into the locking slot via the opening, the toothed section is not removed from the locking slot backward.

10. The mounting assembly as claimed in claim 1, wherein the retaining loop further includes a limiting rib arranged on the peripheral side thereof so as to engage with the affix hole.

11. A mounting assembly comprising:
a body being an elongated plate, and the body including an abutting plane, an opposite face opposite to the abutting plane, a threaded orifice passing through the abutting plane and the opposite face, a top edge, and a bottom edge; a distance between the threaded orifice and the top edge being longer than a distance between the threaded orifice and the bottom edge; and the abutting plane having a connection seat arranged on a lower end thereof adjacent to the threaded orifice;
an engagement strap including a coupling portion formed on a first end thereof, a pull ring mounted on a second end thereof, a toothed section arranged between the coupling portion and the pull ring, and a fitting section defined between the toothed section and the pull ring; the coupling portion of the engagement strap being parallelly in connection with the connection seat of the body so that the engagement strap is limited on an insertion position, and the engagement strap being rotated on an installation position perpendicular to the body; the body and a part of the engagement strap being inserted through a wall having an affix hole on the insertion position;
a retaining loop including an opening defined on a peripheral side thereof, and the retaining loop including a locking slot communicating with the opening; wherein the locking slot accommodates the fitting section of the engagement strap, and as the retaining loop moves to the toothed section of the engagement strap, the locking slot movably engages with the toothed section until the retaining loop contacts with the wall; and wherein another part of the engagement strap outside the retaining loop is cut or is snapped off;
wherein the body further includes a holder and a screw nut fixed in the holder; the screw nut has the threaded orifice defined therein; and the holder has two through orifices arranged on two ends of the screw nut, individually.

12. The mounting assembly as claimed in claim 11, wherein the abutting plane of the body has a recess formed on a bottom thereof and extending toward the connection seat, and the abutting plane has a first stop fringe arranged on a bottom of the recess so as to stop the engagement strap, hence the engagement strap is limited on the insertion position; the connection seat has a notch communicating with the recess and has a second stop fringe defined thereon so as to stop the engagement strap, hence the engagement strap is limited and rotated on the installation position.

13. The mounting assembly as claimed in claim 12, wherein the connection seat further has two apertures defined on two sides of the notch, respectively; the coupling portion of the engagement strap has two flexible posts extending outwardly from two sides thereof respectively, and each of the two flexible posts is rotatably connected with each of the two apertures of the connection seat.

14. The mounting assembly as claimed in claim 11, wherein the abutting plane of the body has a protrusion surrounding the threaded orifice and configured to retain in the affix hole.

15. The mounting assembly as claimed in claim 11, wherein the holder is injection molded from plastic material and covers the screw nut.

16. The mounting assembly as claimed in claim 11, wherein the opposite face of the body obliquely extends to the top edge and the bottom edge from the threaded orifice so that a thickness of the body on the threaded orifice is more than those of the top edge and the bottom edge.

17. The mounting assembly as claimed in claim 11, wherein the toothed section of the engagement strap has multiple first teeth; and the locking slot of the retaining loop has at least one second tooth, such that at least one of the multiple first teeth of the engagement strap retains with the at least one second tooth of the locking slot of the retaining loop.

18. The mounting assembly as claimed in claim 11, wherein a width of the fitting section of the engagement strap is less than the toothed section, hence when the fitting section moves into the locking slot via the opening, the toothed section is not removed from the locking slot backward.

19. The mounting assembly as claimed in claim 11, wherein the retaining loop further includes a limiting rib arranged on the peripheral side thereof so as to engage with the affix hole.
